(19) United States
(12) Patent Application Publication
(10) Pub. No.: US 2016/0280195 A1
(43) Pub. Date: Sep. 29, 2016

(54) Hand Brake Determination Method and System for an Air Brake System and Improved Hand Brake Arrangement

(71) Applicant: WABTEC HOLDING CORP., Wilmerding, PA (US)

(72) Inventors: Robert C. Kull, Olney, MD (US); Timothy Wesley, Cranberry Township, PA (US); Albert J. Neupaver, Venetia, PA (US)

(21) Appl. No.: 15/035,849

(22) PCT Filed: Nov. 7, 2014
(86) PCT No.: PCT/US14/64550

§ 371 Date: May 11, 2016

Related U.S. Application Data
(60) Provisional application No. 61/904,181, filed on Nov. 14, 2013.

(51) Int. Cl. B60T 13/66; B60T 17/22; B61H 13/02

(52) U.S. Cl. CPC B60T 13/665; B61H 13/02; B60T 17/228

(57) ABSTRACT

A computer-implemented method for an air brake system of a train with an air brake system, including: (i) determining consist data associated with the train; (ii) determining track data comprising location data and grade data; (iii) determining required train holding force based at least partially on the consist data and the track data; and (iv) determining hand brake arrangement actuation data based at least partially on the required train holding force. An improved hand brake arrangement is also disclosed.

### CROSS REFERENCE TO RELATED APPLICATIONS

This application claims benefit of priority from U.S. Provisional Patent Application No. 61/904,181, filed Nov. 14, 2013, which is incorporated herein by reference in its entirety.

### BACKGROUND OF THE INVENTION

1. Field of the Invention

The present invention relates generally to braking systems and arrangements for use in connection with an air brake arrangement including hand brake arrangements and the like, and in particular to a hand brake determination method and system for an air brake system for a train, railcar, railway vehicle, locomotive, and similar vehicles, and preferably an electronically-controlled pneumatic air brake system for a railway vehicle.

2. Description of the Related Art

As is known, braking systems and arrangements are required for slowing and stopping vehicles, such as cars, trucks, trains, railcars, railway vehicles, locomotives, and the like. With specific respect to trains and other railway vehicles, the braking system is normally in the form of a pneumatically-driven arrangement (or “air brake arrangement”) having mechanisms and components that interact with each railcar. A known air brake system BA is illustrated in schematic form in FIG. 1.

With reference to FIG. 1, and as is known, the operator of a train TR has control over the braking system BA through the use of an operator control valve CV. Through the movement of a handle associated with the control valve CV, the operator can adjust the amount of braking to be applied in the air brake system BA. The higher the braking force selected, the faster the braking system BA will slow and stop the train TR. Alternatively, and as discussed in more detail hereinafter, the air brake system BA for each railcar may also be controlled by the operator from an on-board controller OBC (which may be in the form of a control system, a train management computer, a computing device, a processor, and/or the like) in the locomotive that transmits data signals over a trainline TL (or cable extending between the locomotive and the railcars), which may be referred to as an electronically-controlled pneumatic (ECP) air brake arrangement.

In order to provide the appropriately compressed air to the system, and in certain conventional air brake applications, the air brake system BA also includes a compressor C for providing compressed air to a main reservoir MR. Further, an equalizing reservoir ER is also in communication with the control valve CV. Whether through the main reservoir MR or the equalizing reservoir ER, compressed air is supplied through the control valve CV to a brake pipe BP that extends along and is associated with each railcar. Each railcar includes an arrangement that allows an auxiliary reservoir AR to be charged with air via a valve V, as well as an air brake arrangement ABB, which includes a brake cylinder BC in communication with the valve V. The brake cylinder BC is operable to move a brake beam BB, which is operationally connected to one or more brake shoes BS, towards and/or against a surface of a wheel W.

In operation, the brake pipe BP is continually charged to maintain a specific pressure, e.g., 90 psi, and each of the auxiliary reservoir AR and emergency reservoir ER (which may be combined into a single volume, or main reservoir) are similarly charged from the brake pipe BP. In order to brake the train TR, the operator actuates the control valve CV and removes air from the brake pipe BP, thereby reducing pressure to a lower level, e.g., 80 psi. The valve arrangement V quits charging the auxiliary reservoir AR and transfers air from the auxiliary reservoir AR to the brake cylinder BC. Normally, using piston-operable arrangement, the brake cylinder BC moves the brake beam BB (and, accordingly, the brake shoe BS) towards and against the wheel W. As discussed, in conventional, non-ECP air brake systems, the operator may adjust the level of braking using the control valve CV, since the amount of pressure removed from the brake pipe BP results in a specific pressure in the brake cylinder BC, which results in a specific application force of the brake shoe BS against the wheel W. Alternatively, in the ECP air brake systems, the brake commands are electronic and transmitted over the ECP trainline TL to each railcar. Using the above-described air brake system BA, the train can be slowed and/or stopped during operation and as it traverses the track. Further, each railcar is normally equipped with a (typically manual) hand brake arrangement HB for securing each car when parked or stopped, and in order to ensure that the train does not move or shift.

In order to provide further control to the air brake arrangement BA, and as discussed above, ECP brake arrangements can be used. In such ECP systems, control signals can be transmitted from the on-board controller OBC, typically located in the cabin of the locomotive and in communication with a display mechanism (i.e., the operator interface), to one or more of the railcars over the trainline TL. Each railcar is normally equipped with a local controller LC, which is used to monitor and/or control certain operating parameters in the air brake arrangement ABB, such as in the air reservoirs and/or the valve arrangement V. In this manner, the operator can broadcast brake commands to the railcars to ensure a smooth, efficient, and effective braking operation. This local controller LC typically includes the appropriate processor and components to monitor and/or control various components of the air brake system BA and/or the specific air brake arrangement ABB.

As discussed above, conventional freight cars include hand brake arrangements FIB, which provide a mechanical locking of brakes, normally based upon user operation of a wheel to apply force to a chain connected to a brake lever system (which is connected to the brake beam BB). Actuation of these hand brake arrangements HB cause the brake shoes BS to contact the wheels W via movement of the brake beams BB. Operating rules have been established by railroads, which require application of the hand brake arrangement HB under a variety of conditions. The most common condition is when “setting a car off” from the train 1K in order to park it in a yard or siding track. However, as referred to above, the hand brake arrangements HB are also used to secure the train TR under failure (or emergency) conditions when in mainline operation. For example, these hand brake arrangements HB may be used when the train TR failure exists, where the locomotives are no longer able to maintain brake pipe BP pressure. Another such condition exists when a crew needs to secure the train TR and leave the locomotive unmanned. A still further condition arises when the train TR suffers a “break-in-two” event, leaving a group of cars without a locomotive.

The “break-in-two” event and other conditions requiring the stopping of a train TR are addressed through exhausting the brake pipe BP, which will lead to an emergency brake application. Typical air brake systems, even if maintained to AAR standards, can have a brake cylinder leak rate of up to 1 psi per minute, which are considered to be within acceptable leakage rates. This level is normally used to provide a time guideline for train crews to gauge when to manually apply the hand brake arrangements HB and secure the train TR. The number of cars that require this hand brake arrangement HB application may vary based on the number of cars in the train consist, the train weight, the track location, the average grade of the track, and similar factors and conditions. Crews normally need to apply the hand brake arrangements HB within about one-half hour after the condition arises, and after the hand brake arrangements HB are applied, the brake cylinder BC can leak to zero, such that the car will be secured.

There exists a need in the industry for better solutions in determining and implementing hand brake arrangement actuation scenarios based upon train data and other data associated with the track and/or location of the train. There is also a need for improved hand brake arrangements that are automated and can effectively function in ECP-based braking systems.

### SUMMARY OF THE INVENTION

Generally, provided is an improved hand brake determination method and system and an improved hand brake arrangement for an air brake arrangement that address and/or overcome various drawbacks and deficiencies that exist in braking systems, particularly with respect to the use of hand, parking, and/or emergency brakes. Preferably, provided is a hand brake determination method and system and an improved hand brake arrangement for an air brake arrangement that are useful in connection with an air brake system of a train and/or railway vehicle, such as a railcar or locomotive. Preferably, provided is a hand brake determination method and system and an improved hand brake arrangement for an air brake arrangement that are useful in connection with an electronically-controlled pneumatic (ECP) braking system of a train.

Accordingly, and in one preferred and non-limiting embodiment or aspect, provided is a computer-implemented method for an air brake system of a train having at least one locomotive and at least one railcar. The air brake system includes: (a) at least one air brake arrangement associated with the at least one railcar and/or the at least one locomotive and configured to directly or indirectly urge at least one brake shoe towards and against at least one wheel of the at least one railcar and/or the at least one locomotive; and (b) at least one hand brake arrangement associated with the at least one railcar and/or the at least one locomotive and configured to directly or indirectly urge the at least one brake shoe towards or hold the at least one brake shoe against the at least one wheel of the at least one railcar and/or the at least one locomotive. The method includes: (i) determining consist data associated with the train; (ii) determining track data comprising location data and grade data; (iii) determining required train holding force based at least partially on the consist data and the track data; and (iv) determining hand brake arrangement actuation data based at least partially on the required train holding force.

In one preferred and non-limiting embodiment or aspect, the consist data includes at least one of the following: a number of cars of the train, a length of the train, a weight of the train, or any combination thereof. In another preferred and non-limiting embodiment or aspect, the method further includes issuing a command to at least one user to set at least one specified hand brake arrangement. In another preferred and non-limiting embodiment or aspect, the hand brake arrangement actuation data includes at least one of the following: a specified number of hand brake arrangements to be actuated, at least one specified hand brake arrangement to be actuated, or any combination thereof.

In another preferred and non-limiting embodiment or aspect, the at least one hand brake arrangement is automated, and the method further includes transmitting a command directly or indirectly to the at least one hand brake arrangement to cause the hand brake arrangement to actuate. The command may be transmitted over an existing trainline extending at least partially along the train. The at least one railcar may include a local controller configured to control the air brake system of the at least one railcar, where the command is transmitted directly or indirectly to the local controller. The at least one hand brake arrangement may include at least one motor configured to mechanically actuate the at least one hand brake and cause the at least one brake shoe to be urged towards or held against the at least one wheel of the at least one railcar and/or the at least one locomotive. The method may further include determining force data for a specified hand brake arrangement based at least partially on motor data, where the motor data may include at least one of the following: motor voltage data, motor current data, torque data, gear data, ratio data, or any combination thereof, and the force data may include holding force data associated with a specified railcar and/or locomotive. The hand brake arrangement may further include at least one linkage directly or indirectly attached at one end to the at least one brake shoe and at the other end to an arrangement configured to move, urge, and/or actuate the at least one linkage, thereby urging the at least one brake shoe towards or holding the at least one brake shoe against the at least one wheel, or releasing the tension, such that the at least one brake shoe moves away or is capable of moving away from the at least one wheel. The method may further include: causing the motor to take up any slack in the at least one linkage; and causing the motor to apply a specified level of torque to the at least one linkage.

In another preferred and non-limiting embodiment or aspect, the method includes receiving feedback data representing at least one of the following: a specified number of hand brake arrangements have or have not been actuated, at least one specified hand brake arrangement has or has not been actuated, force data, incomplete operation data, issue data, alert data, or any combination thereof.

In another preferred and non-limiting embodiment or aspect, the method includes determining whether the at least one air brake arrangement associated with the at least one railcar and/or the at least one locomotive is activated; and if the at least one air brake arrangement is activated, causing the at least one hand brake arrangement to be released. The determining step and the causing step may be implemented through communication over a trainline extending at least partially along the train. The method may include receiving confirmation data that the at least one hand brake arrangement has been released.

In another preferred and non-limiting embodiment or aspect, provided is a system for an air brake system of a train having at least one locomotive and at least one railcar, the air brake system including: (a) at least one air brake arrangement associated with the at least one railcar and/or the at least one locomotive and configured to directly or indirectly urge at least one brake shoe towards and against at least one wheel of the at least one railcar and/or the at least one locomotive; and (b) at least one hand brake arrangement associated with the at least one railcar and/or the at least one locomotive and configured to directly or indirectly urge the at least one brake shoe towards or hold the at least one brake shoe against the at least one wheel of the at least one railcar and/or the at least one locomotive. The system includes at least one computer having a storage medium with program instructions stored thereon, which, when executed by at least one processor of the at least one computer, causes the processor to: (i) determine consist data associated with the train; (ii) determine track data comprising location data and grade data; (iii) determine required train holding force based at least partially on the consist data and the track data; and (iv) determine hand brake arrangement actuation data based at least partially on the required train holding force.

In a further preferred and non-limiting embodiment or aspect, provided is a hand brake arrangement for an air brake system of a train having at least one locomotive and at least one railcar, the air brake system including at least one air brake arrangement associated with the at least one railcar and/or the at least one locomotive and configured to directly or indirectly urge at least one brake shoe towards and against at least one wheel of the at least one railcar and/or the at least one locomotive. The hand brake arrangement includes: at least one linkage directly or indirectly attached at one end to the at least one brake shoe (or brake beam connected to the brake shoe) and at the other end to an arrangement configured to move the at least one linkage, thereby directly or indirectly urging the at least one brake shoe towards or holding the at least one brake shoe against the at least one wheel, or releasing the tension, such that the at least one brake shoe moves away or is capable of moving away from the at least one wheel; a hand wheel in operational engagement with at least one component of the arrangement and configured to rotate the at least one component upon manual rotation of the hand wheel; at least one motor in operational engagement with the at least one component of the arrangement and configured to automatically move the at least one component upon operation of the at least one motor; and at least one hand brake battery configured to at least partially power the at least one motor.

In another preferred and non-limiting embodiment or aspect, the at least one hand brake battery includes at least one rechargeable battery. The at least one rechargeable battery may be charged through at least one of the following: an electrical connection with a trainline extending at least partially along the train, an electrical connection with at least one solar power arrangement, an electrical connection with at least one axle power generator arrangement, an electrical connection with a local controller, or any combination thereof.

In another preferred and non-limiting embodiment or aspect, the at least one hand brake battery is positioned near or mounted on at least one component of the hand brake arrangement. In another preferred and non-limiting embodiment or aspect, the at least one motor is configured to be disengaged from or disabled with respect to at least one component of the hand brake arrangement when in an unpowered state. In another preferred and non-limiting embodiment or aspect, the at least one motor is configured to be selectively disengaged from or disabled with respect to at least one component of the hand brake arrangement. In another preferred and non-limiting embodiment or aspect, the at least one motor is automatically actuated based at least in part upon the sensing or determination of an emergency brake application.

In another preferred and non-limiting embodiment or aspect, and after actuation, the hand brake arrangement is released based upon at least one of the following: a push-button arrangement, a data signal, a data radio signal, or any combination thereof. The actuation or release of the hand brake arrangement may be directly or indirectly communicated to an on-board controller of the train. The communication may be effected over a trainline extending at least partially along the train.

Preferred and non-limiting embodiments or aspects of the present invention will now be described in the following numbered clauses:

Clause 1: A computer-implemented method for an air brake system of a train comprising at least one locomotive and at least one railcar, the air brake system comprising: (a) at least one air brake arrangement associated with the at least one railcar and/or the at least one locomotive and configured to directly or indirectly urge at least one brake shoe towards and against at least one wheel of the at least one railcar and/or the at least one locomotive; and (b) at least one hand brake arrangement associated with the at least one railcar and/or the at least one locomotive and configured to directly or indirectly urge the at least one brake shoe towards or hold the at least one brake shoe against the at least one wheel of the at least one railcar and/or the at least one locomotive, the method comprising: (i) determining consist data associated with the train; (ii) determining track data comprising location data and grade data; (iii) determining required train holding force based at least partially on the consist data and the track data; and (iv) determining hand brake arrangement actuation data based at least partially on the required train holding force.

Clause 2: The computer-implemented method of clause 1, wherein the consist data comprises at least one of the following: a number of cars of the train, a length of the train, a weight of the train, or any combination thereof.

Clause 3: The computer-implemented method of clause 1 or 2, further comprising issuing a command to at least one user to set at least one specified hand brake arrangement.

Clause 4: The computer-implemented method of any of clauses 1-3, wherein the hand brake arrangement actuation data comprises at least one of the following: a specified number of hand brake arrangements to be actuated, at least one specified hand brake arrangement to be actuated, or any combination thereof.

Clause 5: The computer-implemented method of any of clauses 1-4, wherein the at least one hand brake arrangement is automated, the method further comprising transmitting a command directly or indirectly to the at least one hand brake arrangement to cause the hand brake arrangement to actuate.

Clause 6: The computer-implemented method of clause 5, wherein the command is transmitted over an existing trainline extending at least partially along the train.

Clause 7: The computer-implemented method of clause 5 or 6, wherein the at least one railcar comprises a local controller configured to control the air brake system of the at least one railcar, the command transmitted directly or indirectly to the local controller.

Clause 8: The computer-implemented method of any of clauses 5-7, wherein the at least one hand brake arrangement comprises at least one motor configured to mechanically actuate the at least one hand brake and cause the at least one brake shoe to be urged towards or held against the at least one wheel of the at least one railcar and/or the at least one locomotive.

Clause 9: The computer-implemented method of clause 8, further comprising determining force data for a specified hand brake arrangement based at least partially on motor data.

Clause 10: The computer-implemented method of clause 8 or 9, wherein the motor data comprises at least one of the following: motor voltage data, motor current data, torque data, gear data, ratio data, or any combination thereof.

Clause 11: The computer-implemented method of any of clauses 8-10, wherein the force data comprises holding force data associated with a specified railcar and/or locomotive.

Clause 12: The computer-implemented method of any of clauses 8-11, wherein the hand brake arrangement further comprises at least one linkage directly or indirectly attached at one end to the at least one brake shoe and at the other end to an arrangement configured to move, urge, and/or actuate the at least one linkage, thereby urging the at least one brake shoe towards or holding the at least one brake shoe against the at least one wheel, or releasing the tension, such that the at least one brake shoe moves away or is capable of moving away from the at least one wheel.

Clause 13: The computer-implemented method of clause 12, further comprising: causing the motor to take up any slack in the at least one linkage; and causing the motor to apply a specified level of torque to the at least one linkage.

Clause 14: The computer-implemented method of any of clauses 1-13, further comprising receiving feedback data representing at least one of the following: a specified number of hand brake arrangements have or have not been actuated, at least one specified hand brake arrangement has or has not been actuated, force data, incomplete operation data, issue data, alert data, or any combination thereof.

Clause 15: The computer-implemented method of any of clauses 1-14, further comprising: determining whether the at least one air brake arrangement associated with the at least one railcar and/or the at least one locomotive is activated; and if the at least one air brake arrangement is activated, causing the at least one hand brake arrangement to be released.

Clause 16: The computer-implemented method of clause 15, wherein the determining step and the causing step are implemented through communication over a trainline extending at least partially along the train.

Clause 17: The computer-implemented method of clause 16, further comprising receiving confirmation data that the at least one hand brake arrangement has been released.

Clause 18: A system for an air brake system of a train comprising at least one locomotive and at least one railcar, the air brake system comprising: (a) at least one air brake arrangement associated with the at least one railcar and/or the at least one locomotive and configured to directly or indirectly urge at least one brake shoe towards and against at least one wheel of the at least one railcar and/or the at least one locomotive; and (b) at least one hand brake arrangement associated with the at least one railcar and/or the at least one locomotive and configured to directly or indirectly urge the at least one brake shoe towards or hold the at least one brake shoe against the at least one wheel of the at least one railcar and/or the at least one locomotive, the system comprising: on at least one computer having a storage medium with program instructions stored thereon, which, when executed by at least one processor of the at least one computer, causes the processor to: (i) determine consist data associated with the train; (ii) determine track data comprising location data and grade data; (iii) determine required train holding force based at least partially on the consist data and the track data; and (iv) determine hand brake arrangement actuation data based at least partially on the required train holding force.

Clause 19: A hand brake arrangement for an air brake system of a train comprising at least one locomotive and at least one railcar, the air brake system comprising at least one air brake arrangement associated with the at least one railcar and/or the at least one locomotive and configured to directly or indirectly urge at least one brake shoe towards or hold the at least one brake shoe against at least one wheel of the at least one railcar and/or the at least one locomotive, the hand brake arrangement comprising: at least one linkage directly or indirectly attached at one end to the at least one brake shoe and at the other end to an arrangement configured to move, urge, and/or actuate the at least one linkage, thereby directly or indirectly urging the at least one brake shoe towards or holding the at least one brake shoe against the at least one wheel, or releasing the tension, such that the at least one brake shoe moves away or is capable of moving away from the at least one wheel; a hand wheel in operational engagement with at least one component of the arrangement and configured to move the at least one component upon manual rotation of the hand wheel; at least one motor in operational engagement with the at least one component of the arrangement and configured to automatically move the at least one component upon operation of the at least one motor; and at least one hand brake battery configured to at least partially power the at least one motor.

Clause 20: The hand brake arrangement of clause 19, wherein the at least one hand brake battery comprises at least one rechargeable battery.

Clause 21: The hand brake arrangement of clause 20, wherein the at least one rechargeable battery is charged through at least one of the following: an electrical connection with a trainline extending at least partially along the train, an electrical connection with at least one solar power arrangement, an electrical connection with at least one axle power generator arrangement, an electrical connection with a local controller, or any combination thereof.

Clause 22: The hand brake arrangement of any of clauses 19-21, wherein the at least one hand brake battery is positioned near or mounted on at least one component of the hand brake arrangement.

Clause 23: The hand brake arrangement of any of clauses 19-22, wherein the at least one motor is configured to be disengaged from or disabled with respect to at least one component of the hand brake arrangement when in an unpowered state.

Clause 24: The hand brake arrangement of any of clauses 19-23, wherein the at least one motor is configured to be selectively disengaged from or disabled with respect to at least one component of the hand brake arrangement.

Clause 25: The hand brake arrangement of any of clauses 19-24, wherein the at least one motor is automatically actuated based at least in part upon the sensing or determination of an emergency brake application.

Clause 26: The hand brake arrangement of any of clauses 19-25, wherein, after actuation, the hand brake arrangement is released based upon at least one of the following: a push-button arrangement, a data signal, a data radio signal, or any combination thereof.

Clause 27: The hand brake arrangement of clause 26, wherein the actuation or release of the hand brake arrangement is directly or indirectly communicated to an on-board controller of the train.

Clause 28: The hand brake arrangement of clause 27, wherein the communication is effected over a trainline extending at least partially along the train.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of an air brake arrangement for a train according to the prior art;

FIG. 2 is a perspective view of an air brake arrangement for a train according to the prior art;

FIG. 3 is a schematic view of one embodiment or aspect of a hand brake arrangement according to the principles of the present invention;

FIG. 4 is a schematic view of another embodiment or aspect of a hand brake arrangement according to the principles of the present invention;

FIG. 5 is a schematic view of a further embodiment or aspect of a hand brake arrangement according to the principles of the present invention;

FIG. 6 is a schematic view of a method and system for use in connection with a hand brake arrangement of an air brake system according to the principles of the present invention; and

FIG. 7 is a schematic view of a computer system environment according to the prior art.

### DETAILED DESCRIPTION OF THE PREFERRED EMBODIMENT OR ASPECTS

For purposes of the description hereinafter, the terms “end”, “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” refer to the receipt, transmission, or transfer of one or more signals, messages, commands, or other type of data. For one unit or device to be in communication with another unit or device means that the one unit or device is able to receive data from and/or transmit data to the other unit or device. A communication may use a direct or indirect connection, and may be wired and/or wireless in nature. Additionally, two units or devices may be in communication with each other even though the data transmitted may be modified, processed, routed, etc., between the first and second unit or device. For example, a first unit may be in communication with a second unit even though the first unit passively receives data, and does not actively transmit data to the second unit. As another example, a first unit may be in communication with a second unit if an intermediary unit processes data from one unit and transmits processed data to the second unit. It will be appreciated that numerous other arrangements are possible. Any known electronic communication protocols and/or algorithms may be used, such as, for example, TCP/IP (including HTTP and other protocols), WLAN (including 802.11 and other radio frequency-based protocols and methods), analog transmissions, and/or the like. Further, a variety of wired or wireless network devices may be used, including, but not limited to, a wireless network device, a wired network device, a WiFi network device, a Bluetooth network device, a Zigbee network device, a WirelessHART network device, a GPRS network device, an ultra-wideband network device, a cable network device, a wideband network device, a multi-radio network device, and the like.

As discussed above, the use of an air brake system BA in connection with a train TR hand brake arrangements HB on the locomotive and/or railcars of the train TR is well known. One such known braking arrangement is illustrated in FIG. 2 of the present application, which has been copied from page 5 of Freight Car Brake Rigging Arrangements, Student Workbook, TP2008, June 2004 (“Student Workbook”) of Wabtec Corporation. The Student Workbook is incorporated herein in its entirety. FIG. 2 illustrates a conventional or foundation brake rigging arrangement for a freight car, and various hand brake arrangements HB are shown and described on pages 17-19 of the Student Workbook.

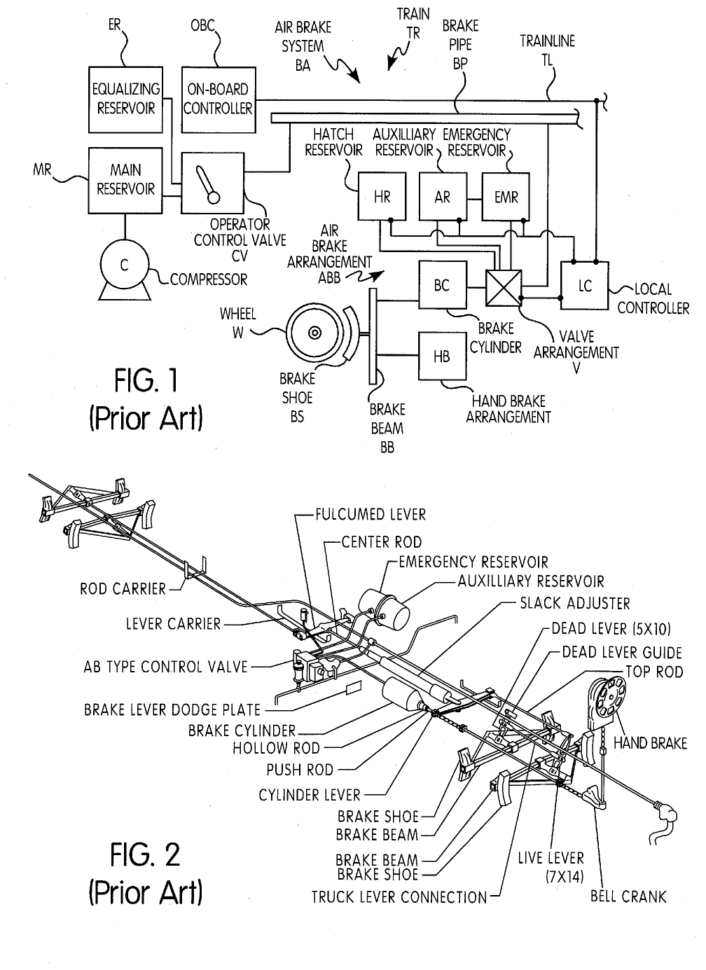

The present invention is directed to a hand brake determination system and method for an air brake system BA for a train TR having at least one railcar R and at least one locomotive L, as well as an improved hand brake arrangement 10. The presently-invented hand brake determination system and method can be used in connection with existing air brake systems BA (as described above and illustrated in FIGS. 1 and 2), as well as an improved hand brake arrangement 10, as described in greater detail below.

It should be noted that while the system, method, and arrangement 10 of the present invention are specifically discussed herein in connection with a pneumatically-driven brake arrangement (air brake system BA) for a train TR or railway vehicle, they are equally applicable and useful in connection with a variety of braking arrangements and applications involving vehicles with air-based braking systems. Accordingly, the system, method, and arrangement 10 may also be used in connection with roadway vehicles, such as cars, trucks, buses, etc. For example, many of these vehicles include similar braking arrangements that use pneumatic-driven braking systems for slowing or stopping the vehicle. Accordingly, while predominantly discussed in connection with railway vehicles, all similar applications are envisioned and may be used in connection with the system, method, and arrangement 10 of the present invention.

Similarly, the system, method, and arrangement 10 of the present invention can be used in a variety of types of braking arrangements and braking systems used in the railroad industry. In particular, the presently-invented system, method, and arrangement 10 are equally useful in connection with the air brake arrangement ABB of a railcar R, as well as the air brake arrangement ABB of the locomotive L or engine. Still further, while the system, method, and arrangement 10 of the present invention is preferably used in connection with electronically-controlled pneumatic (ECP) air brake systems, it can also be used in connection with conventional braking systems, dynamic braking systems, blended or combination braking systems, emergency braking systems, and the like.

In one preferred and non-limiting embodiment or aspect, the present invention is directed to an improved hand brake arrangement 10. The hand brake arrangement 10 is provided on or implemented in connection with the air brake system BA of the train TR, where each of the railcars R and/or the locomotives L is equipped with this hand brake arrangement 10. In operation, the hand brake arrangement 10 is configured or operable to directly or indirectly urge the brake shoes BS towards a wheel W of the railcar R (or locomotive L) or hold the brake shoe BS against the wheel W of the railcar R or locomotive L.

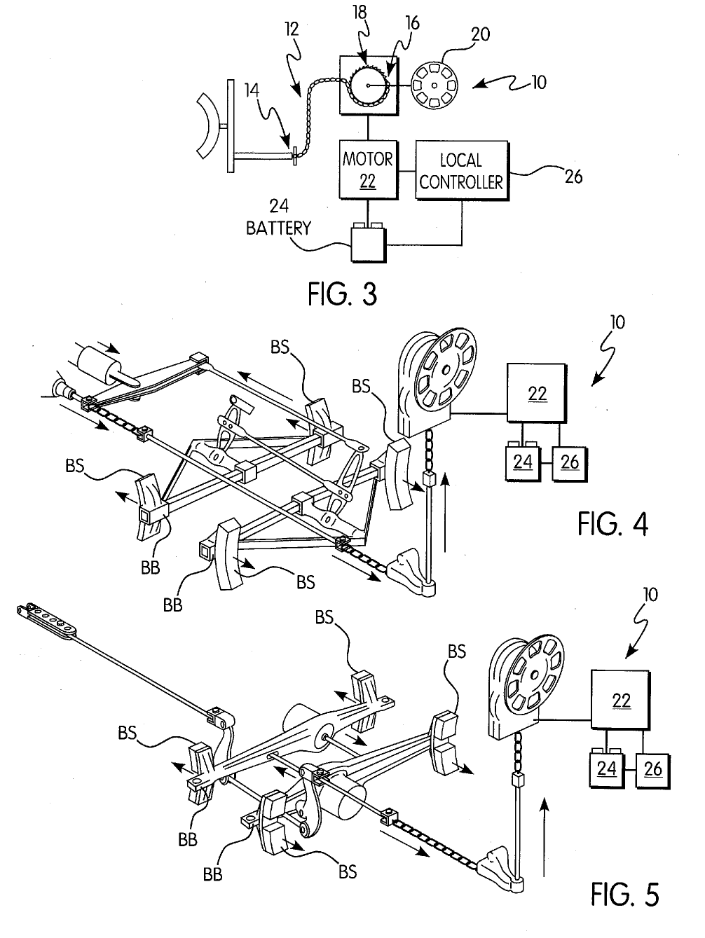

As seen in FIGS. 3-5, and in one preferred and non-limiting embodiment or aspect, the hand brake arrangement 10 includes a linkage 12 (e.g., chains, rods, a mechanical linkage, and the like) directly or indirectly attached at a first end 14 to a brake beam BB or brake shoe BS, and connected or attached at a second end 16 of the linkage 12 to an arrangement 18, such as a ratchet arrangement or similar mechanical arrangement configured to move, urge, and/or actuate at least a portion of the linkage 12. The arrangement 18, which may take a variety of forms and configurations, is operable to wind and/or unwind (or otherwise move) the linkage 12. In particular, the arrangement 18 is configured to rotate and move the linkage 12, thereby moving the brake beams BB and urging the brake shoe BS towards or holding the brake shoe BS against the wheel W. Similarly, the tension can be released, such that the brake shoe BS moves away from or is capable of moving away from the wheel W.

In order to manually actuate the arrangement 18, the hand brake arrangement 10 includes a wheel 20, which allows a user to rotate the wheel 20, thereby rotating the arrangement 18 in the desired direction and actuate or release the hand brake arrangement 10. The wheel 20 is in operational engagement with at least one component of the arrangement 18, such that this component or part can be moved or otherwise actuated upon manual rotation of the wheel 20. As discussed above, the “linkage” 12 refers to the mechanical linkage between the arrangement 18 and the brake beams BB or brake shoes BS. It is envisioned that the linkage 12 may include a bell crank, a truck lever connection, a top rod, a dead lever guide, a dead lever, a cylinder lever, a push rod, a hollow rod, and/or a brake cylinder. However, any such mechanical and/or pneumatic linkages or arrangements between the hand brake arrangement 10 and, directly or indirectly, the brake beams BB or brake shoes BS are envisioned within the scope and spirit of the present application. By way of example, the presently-invented hand brake arrangement 10 is illustrated in use in connection with body mounted brakes in FIG. 4 and a truck mounted arrangement in FIG. 5.

With continued reference to FIGS. 3-5, and in another preferred and non-limiting embodiment or aspect, the hand brake arrangement 10 includes at least one motor 22 or similar device in operational engagement with the above-discussed component of the arrangement 18. The motor 22 is configured to automatically rotate a component upon operation or actuation of the motor 22, which provides an automated hand brake arrangement 10 (where the linkage 12 is moved). This motor 22 may be at least partially powered locally at the railcar R or locomotive L, or over some other electrical system or electro-pneumatic system.

In another preferred and non-limiting embodiment or aspect, the hand brake arrangement 10 includes at least one hand brake battery 24, which is configured to at least partially power the motor 22 and, thereby, operate or actuate the hand brake arrangement 10. In one preferred and non-limiting embodiment or aspect, the hand brake battery 24 is in the form of a rechargeable battery, which may be charged through an electrical connection with the train line TL, an electrical connection with a solar power arrangement, an electrical connection with an axle power generator arrangement, or any similar arrangement or assembly that can provide power to the rechargeable battery 24.

In another preferred and non-limiting embodiment or aspect, the hand brake battery 24 is positioned near or mounted on the component of the arrangement 18 that operates the linkage 12. Further, the motor 22 may be configured or operable to be disengaged from or disabled with respect to the component of the arrangement 18 (or hand brake arrangement 10), and this disengagement or disabling may be selectively implemented, such as through a command or a communication with a local controller 26. It is further envisioned that the local controller 26 may be used to provide power to the battery 24, and configured to control or monitor various components and conditions in the air brake system BA. For example, and as illustrated in FIGS. 3-5, the local controller 26 is in direct or indirect, wired or wireless communication with one or more sensors, monitors, or components within the hand brake arrangement 10. For example, the local controller 26 may be used to monitor the position, state, condition, or orientation of the various components in the air brake system BA or the hand brake arrangement HB or 10, e.g., the position of the wheel 20, the state of the linkage 12, a parameter associated with the motor 26, a parameter associated with the battery 24, and the like.

In one preferred and non-limiting embodiment or aspect, the motor 22 is automatically operated or actuated based at least in part upon the sensing or determination of an emergency brake application in the air brake system BA. In addition, and in another embodiment or aspect, after actuation, the hand brake arrangement 10 may be released based upon a push-button arrangement, a data signal, a data radio signal, or the like. Further, the actuation or release of the hand brake arrangement 10 may be communicated to an on-board controller OBC of the train TR, such as over the train line TL. Of course, this communication may be wirelessly implemented or effected, and facilitated using the local controller 26.

As is known, and according to the Association of American Railroads (AAR) Standard S-4200 (relating to electronically-controlled pneumatic brake systems), a total power budget of 10 watts per railcar R is typically provided. In one preferred and non-limiting embodiment or aspect, the air brake arrangement ABB of each individual railcar R may appropriately operate and function with under 5 watts, which provides an energy budget to support other railcar R functions. It is envisioned that the hand brake arrangement 10 according to the present invention be allocated a portion of this budget, such as about 2 watts. This power budget could be used to charge the battery 24 on a “trickle-charge” basis. When the motor 22 is powered, it will require much higher power levels that could be provided from the battery 24. However, since hand brake applications are not used often, the battery 24 can recharge between applications. In one preferred and non-limiting embodiment or aspect, the battery 24 is a 5 amp-hour battery, which would support at least five applications and releases from a fully charged state of the hand brake arrangement 10. In addition, multiple batteries 24 can be provided for backup.

As discussed, and in one preferred and non-limiting embodiment or aspect, the battery 24 may be located near, or even mounted on, the housing that encloses the arrangement 18 into which the wheel 20 is attached. In this manner, the cable length between the battery 24 and motor 22 can be minimized. The current of the motor 22 may be high during operation, such that there would be a benefit to minimizing both the cost and power losses associated with the power cable. In one preferred and non-limiting embodiment or aspect, the motor design would be based on 12 VDC to work with standard high-volume, low-cost motors, as well as the 12 VDC battery and battery charging system of the air brake system BA. However, it may be preferable to provide a higher voltage motor, including an inverter from the 12 VDC battery, to allow smaller-sized cabling to the hand brake motor 22.

In another preferred and non-limiting embodiment or aspect, the motor 22 is placed in operational engagement with the arrangement 18 or other component of the hand brake arrangement 10 in a variety of manners. For example, the motor 22 may have a pinion gear applied to the main hand brake gear, or alternatively, by a gear motor applied to the existing shaft. In both instances, it is still necessary to allow for the manual application of the hand brake using the wheel 20, preferably without adding unnecessary load. Therefore, and as discussed above, the hand brake arrangement 10 may be configured to allow the motor/gear to be disengaged when not powered.

As discussed above, the battery 24 may be charged through various connections, such as the train line TL or other parts of the air brake system BA. However, different implementations could also be used in connection with conventional non-ECP brake cars. For example, some on-board power source may be provided to charge the battery 24. As also discussed, automatic application of the hand brake arrangement 10 may be based upon the detection of an emergency brake application, and release may be based upon some other signal or actuatable mechanism. In addition, if the hand brake arrangement 10 is remotely controlled or monitored, some signal or confirmation may be provided to the on-board controller OBC indicating that the hand brake arrangement 10 has either been applied and/or released.

In this manner, the hand brake arrangement 10 according to the present invention provides automation to the application and release of the arrangement 10, as well as the monitoring of hand brake status, such as over the train line TL, from the locomotive L. Further, and as discussed, the hand brake arrangement 10 may share in the ECP braking power budget to provide the electrical power to the motor 22 of the hand brake arrangement 10, which minimizes the electrical energy required based upon using the air brake arrangement ABB with railcar pneumatics for the initial brake application, before the electric application of the hand brake arrangement 10.

In another preferred and non-limiting embodiment or aspect, the present invention is directed to a computer-implemented method and system for an air brake system BA of the train TR, which includes at least one locomotive L and at least one railcar R. The air brake system BA includes at least one air brake arrangement ABB associated with the railcar R and/or locomotive L, which is configured to directly or indirectly urge the brake shoes BS (such as through the brake beams BB) towards and against the wheel W of the railcar R and/or locomotive L. In addition, the air brake arrangement ABB includes at least one hand brake arrangement 10 associated with the railcar R and/or locomotive L, which is configured to directly or indirectly urge the brake shoe BS (such as through the brake beam BB) towards and against the wheel W of the railcar R and/or locomotive L, or, alternatively, hold the brake shoe BS against the wheel W.

In one preferred and non-limiting embodiment or aspect, the computer-implemented method includes: (i) determining consist data associated with the train TR; (ii) determining track data including location data and grade data; (iii) determining required train holding force based at least partially on the consist data and the track data; and (iv) determining hand brake arrangement actuation data based at least partially on the required train holding force. In another embodiment or aspect, the consist data includes the number of railcars R in the train TR, the length of the train TR, and/or the weight of the train TR.

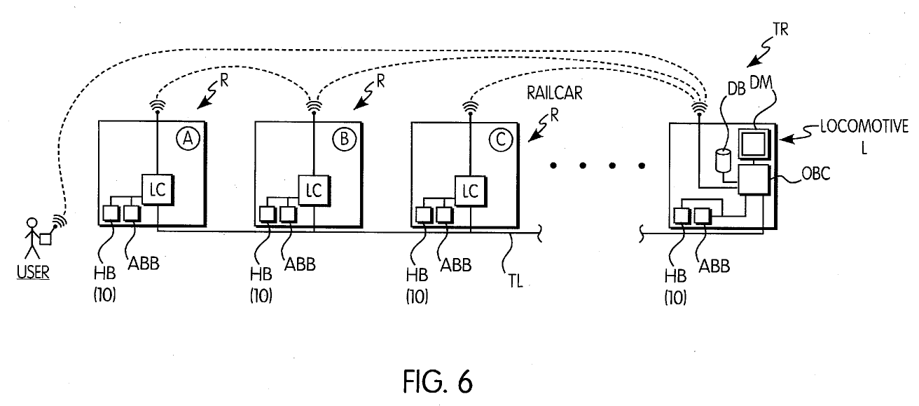

As illustrated in one preferred and non-limiting embodiment or aspect in FIG. 6, each of the railcars R, as well as the locomotive L, are equipped with an individual air brake arrangement ABB and a hand brake arrangement HB or 10. In addition, each railcar R includes a local controller LC that is configured or operable to communicate with and/or control the air brake arrangement ABB, as well as the hand brake arrangement HB, such as the automated hand brake arrangement 10 discussed above.

With further reference to the embodiment or aspect of FIG. 6, the locomotive L includes the above-discussed on-board controller OBC, which is in communication with at least one database DB, which includes or can be populated with any of the discussed data, e.g., consist data, track data, location data, grade data, train holding force data, hand brake arrangement actuation data, and the like. Furthermore, the on-board controller OBC is in communication with at least one display mechanism DM, such as the operators display in the cab of the locomotive L, which provides a user interface to the engineer.

In order to determine the hand brake arrangement actuation data, as well as to communicate commands, signals, or instructions based upon this hand brake arrangement actuation data, a variety of communication paths may be established. For example, the on-board controller OBC may be configured or programmed to send or facilitate communication over a data radio network to at least one user instructing them to manually apply a specified number of hand brake arrangements and/or a specific hand brake arrangement of a particular railcar R. This same information may be provided wirelessly over a train network established between the locomotives L and the railcars R (using the on-board controller OBC and the various local controllers LC). Further, this information may be communicated over the train line TL from the on-board controller OBC to the specified local controllers LC. Still further, the local controllers LC of the railcars R and the on-board controller OBC of the locomotives L may establish communication with one or more wayside interface units or “WIUs”. The wayside interface units WIUs may be configured to establish or facilitate a network (e.g., a cellular-based network) and/or network communications for and between the railcars R and the locomotives L. By providing this communication, whether wirelessly or over the train line TL, and when using an automated hand brake arrangement HB, such as the automated hand brake arrangement 10 discussed above, the hand brake arrangement 10 on any number of railcars R or specific railcars R can be actuated based upon the hand brake arrangement actuation data to achieve or provide the required train holding force.

With continued reference to the preferred and non-limiting embodiment or aspect of FIG. 6, the hand brake arrangement actuation data may make specific determinations for each specific train TR based upon the data associated with the train TR, such as information or data associated with the railcars R, locomotives L, the environment, the location, and the like. For example, it may be determined that, based at least in part upon the consist data and track data, the required train holding force may be provided by a specific number of actuated hand brake arrangements HB or 10 in the train TR. Accordingly, and whether automatically or manually, the specified number of hand brake arrangements HB or 10 may be actuated based upon communications and either a manual application or automated application. For example, the local controller LC (or user) may receive a communication from the on-board controller OBC (or over the radio data network) to actuate or cause the actuation of two hand brake arrangements HB or 10, and the local controller (or user) actuates or causes the actuation of the hand brake arrangements HB or 10 of railcar A and railcar B (thus meeting the required actuation of two hand brake arrangements HB or 10). Alternatively, and based upon the data, the determination or hand brake arrangement actuation data may include specific hand brake arrangements HB or 10 on specific railcars R to be actuated, e.g., railcar A and railcar C. This determination may be based upon the operating conditions, the location of the railcar R in the consist, measured or determined data associated with a specified hand brake arrangement HB or 10 (or the conditions or status of other parts or components of the train TR, railcar R, locomotive L, air brake system AB, etc.), the status of such a hand brake arrangement HB or 10, information derived from a sensor or monitor 25, or any other data point that provides information for the on-board controller OBC (or local controllers LC) to ensure that the proper and required train holding force is provided for the specified environment and location.

When using an automated hand brake arrangement, such as the automated hand brake arrangement 10 discussed above, and as discussed above, the local controller LC may be configured or programmed to control the air brake arrangement ABB and hand brake arrangement 10 based upon instructions from the on-board controller OBC. Of course, it is further envisioned that any specific local controller LC may make the same determinations given the required data or access to the database DB. Further, the on-board controller OBC and/or a local controller LC may determine force data for a specified hand brake arrangement based upon the data associated with a motor 22. This motor data may include motor voltage data, motor current data, torque data, gear data, and/or ratio data. In addition, the force data may include the holding force data associated with a specified railcar R and/or locomotive L. When using the hand brake arrangement 10 described above, which includes the linkage 12, the local controller LC may be configured or programmed to cause or instruct the motor 22 to take up any slack in the linkage 12, and further cause the motor 22 to apply a specified level of torque to the linkage 12.

In a further preferred and non-limiting embodiment or aspect, feedback data is generated by the local controller LC and/or communicated to the on-board controller OBC. This feedback data may indicate that a specified number of hand brake arrangements FIB or 10 have or have not been actuated, that any particular or specific hand brake arrangement FIB or 10 has or has not been actuated, force data associated with the actuation event, an indication that the operation is incomplete or some other error or issue has occurred, or an alert associated with an error condition. In another preferred and non-limiting embodiment or aspect, the local controller LC and/or the on-board controller OBC determines whether the air brake arrangement ABB associated with any number of or specific railcar R and/or locomotive L is activated. If the target air brake arrangement ABB is activated, the on-board controller OBC and/or local controller LC may provide an instruction or otherwise cause the release of the hand brake arrangement HB or 10. This operation may be implemented through communication over any of the communication paths discussed above, such as the train line TL that extends along the train TR. In addition, confirmation data may be communicated to the local controller LC and/or the on-board controller OBC confirming that the specific hand brake arrangement HB or 10 has been released. In another preferred and non-limiting embodiment or aspect, the local controller LC and/or the on-board controller OBC may determine whether the air brake arrangement ABB associated with any specific railcar R and/or locomotive L is activated. If it is determined that the specified or target air brake arrangement ABB is activated, the local controller LC and/or the on-board controller OBC may facilitate or cause the hand brake arrangement HB or 10 to be released.

In one exemplary embodiment or aspect and environment, the engineer in the lead locomotive L stops the train TR and initiates an automated hand brake request via the on-board controller OBC, such as through an interface on a display mechanism DM. This automated application request command may be sent as a special message over the train line TL to all of the railcars R. Each individual railcar air brake arrangement ABB applies the maximum brake cylinder pressure as the first step in the application process. This is based on equalizing the reservoir with the brake cylinder BC, which will apply maximum available pneumatic pressure in all cylinders to set the brakes. After the brake cylinder BC pressure is applied, the local controller LC will command a hand brake motor 22 to rotate the arrangement 18 to take up the linkage 12 slack. At the end of the slack, the motor 22 will provide maximum torque to place tension in the linkage 12, with the linkage 12 held with the arrangement 18. This maximum torque may be applied based upon a sensor that determines when the slack has been “taken up.”

Next, and in this embodiment or aspect, the hand brake motor 22 voltage or current is monitored at the end of the stroke to estimate the force level applied to the hand brake arrangement 10. This can be used to estimate the brake shoe BS or holding force, as applied to each railcar R. This determination may be based upon the proportional association of the motor voltage/current to a calculated torque, and translated into train force. This force data may be estimated based upon gear ratio data or other known formulae associated with the motor.

Next, the hand brake arrangement set status, including the above-discussed force measurement, may be communicated over the train line TL back to the locomotive L. The display mechanism DM in the locomotive L may provide a summary of the total train holding force, based upon the number of railcars R with hand brake arrangements 10 set, as well as the estimated total holding force. The locomotive L is also equipped with positive train control, such as is the case with the Wabtec ETMS®, and the train holding force may also be compared to the required level to safely hold the train TR, based upon consist data (e.g., number of cars, total weight, and average grade under the train TR), as collected or determined from the database DB and location information.

To release the hand brake arrangements 10, and in this exemplary embodiment or aspect, the engineer in the lead locomotive L makes a full service brake application to hold the train TR before initiating the release process. A release command is initiated via the on-board controller OBC, and communicated to all of the railcars R. Each railcar R would ensure pneumatic brakes are applied before releasing the hand brake arrangement 10, and the release of the hand brake arrangements 10 may occur by reversing the motor 22, or by some separate actuator for moving the release lever on the hand brake arrangement 10. Finally, a hand brake release confirmation communication is sent over the train line TL to the locomotive L.

The local controller LC may be in the form of, integrated with, or placed with an existing controller or computer. In particular, any of the determinations or steps in the above-described computer-implemented method may be implemented on the local controller LC (e.g., a control system, a computer, a computing device, a processor, and/or the like), the on-board controller OBC (e.g, a control system, a train management computer, a computing system, a processor, and/or the like), a remote computer or controller, and the like. As discussed, such on-board controllers OBC are known in the industry, and may be part of a positive train control system. Further, such systems rely upon various databases and on-board analyses to provide the operator with accurate train control information, as well as to confirm safe train operation. In addition, and as discussed, the communication paths and platforms may vary. Accordingly, the necessary communication devices may be placed or used in connection with a locomotive L and the railcars R, and include receivers for receiving or transmitting the discussed data. Such a receiver may be a transceiver, a receiver capable of receiving and/or transmitting wireless signals and/or a receiver capable of receiving hard-wired (e.g., train line TL and/or rail-based) signals. The receiver may also obtain data from a variety of sources, e.g., a central dispatch system (or a central controller), a wayside unit, a wayside-based detection system, an off-board database, and the like.

In another preferred and non-limiting embodiment or aspect, the required train holding force data, the hand brake arrangement actuation data, the force data, the feedback or confirmation data, or any other information involved with implementing the presently-invented method and system may be provided to some remote central controller, e.g., central dispatch, a remote server, a remote computing device, a remote processor, and/or the like, and stored in a database. This central controller may be in communication with the on-board controller OBC and/or the local controllers LC on the railcars R of the train TR via the receiver or communication devices discussed above. Accordingly, the information, including the specific deployment of the hand brake arrangement 10, as well as other train control information and data, may be communicated to the train TR for use in making train control decisions. As discussed, any number of communication paths and data transfer processes are envisioned within the context and environment of the present invention.

In this manner, the present invention provides a computer-implemented method for determining and controlling hand brake arrangements, as well as an improved hand brake arrangement for use in an air brake system of a train.

The present invention, including the various computer-implemented and/or computer-designed aspects and configurations, may be implemented on a variety of computing devices and systems, including the client devices and/or server computer, wherein these computing devices include the appropriate processing mechanisms and computer-readable media for storing and executing computer-readable instructions, such as programming instructions, code, and the like. In addition, aspects of this invention may be implemented on existing controllers, control systems, and computers integrated or associated with, or positioned on, the locomotives or the railcars of a train. For example, the presently-invented system or any of its functional components can be implemented wholly or partially on a train management computer, a Positive Train Control (PTC) computer, an on-board controller or computer, a railcar computer, and the like. Still further, the functions and computer-implemented features of the present invention may be in the form of software, firmware, hardware, programmed control systems, microprocessors, and the like.

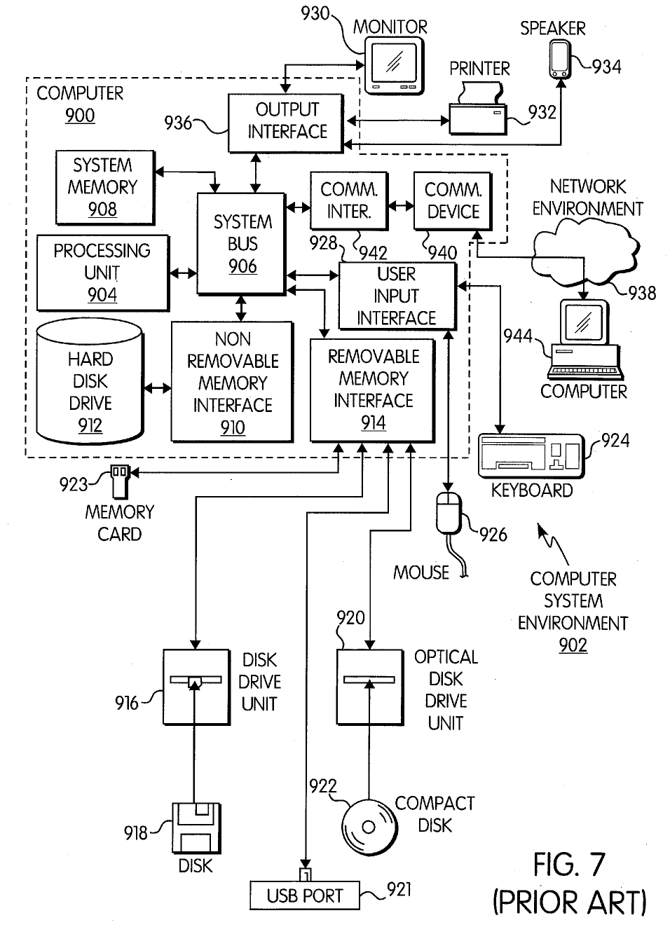

As shown in FIG. 7, the local controllers LC and/or the on-board controller OBC may be in the form of one or more computers 900, 944, in a computing system environment 902. This computing system environment 902 may include, but is not limited to, at least one computer 900 having certain components for appropriate operation, execution of code, and creation and communication of data. For example, the computer 900 includes a processing unit 904 (typically referred to as a central processing unit or CPU) that serves to execute computer-based instructions received in the appropriate data form and format. Further, this processing unit 904 may be in the form of multiple processors executing code in series, in parallel, or in any other manner for appropriate implementation of the computer-based instructions.

In order to facilitate appropriate data communication and processing information between the various components of the computer 900, a system bus 906 is utilized. The system bus 906 may be any of several types of bus structures, including a memory bus or memory controller, a peripheral bus, or a local bus using any of a variety of bus architectures. In particular, the system bus 906 facilitates data and information communication between the various components (whether internal or external to the computer 900) through a variety of interfaces, as discussed hereinafter.

The computer 900 may include a variety of discrete computer-readable media components. For example, this computer-readable media may include any media that can be accessed by the computer 900, such as volatile media, non-volatile media, removable media, non-removable media, etc. As a further example, this computer-readable media may include computer storage media, such as media implemented in any method or technology for storage of information, such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 900. Further, this computer-readable media may include communications media, such as computer-readable instructions, data structures, program modules, or other data in other transport mechanisms and include any information delivery media, wired media (such as a wired network and a direct-wired connection), and wireless media. Computer-readable media may include all machine-readable media with the sole exception of transitory, propagating signals. Of course, combinations of any of the above should also be included within the scope of computer-readable media.

As seen in FIG. 7, the computer 900 further includes a system memory 908 with computer storage media in the form of volatile and non-volatile memory, such as ROM and RAM. A basic input/output system (BIOS) with appropriate computer-based routines assists in transferring information between components within the computer 900 and is normally stored in ROM. The RAM portion of the system memory 908 typically contains data and program modules that are immediately accessible to or presently being operated on by processing unit 904, e.g., an operating system, application programming interfaces, application programs, program modules, program data, and other instruction-based computer-readable codes.

With continued reference to FIG. 7, the computer 900 may also include other removable or non-removable, volatile or non-volatile computer storage media products. For example, the computer 900 may include a non-removable memory interface 910 that communicates with and controls a hard disk drive 912, i.e., a non-removable, non-volatile magnetic medium; and a removable, non-volatile memory interface 914 that communicates with and controls a magnetic disk drive unit 916 (which reads from and writes to a removable, non-volatile magnetic disk 918), an optical disk drive unit 920 (which reads from and writes to a removable, non-volatile optical disk 922, such as a CD ROM), a Universal Serial Bus (USB) port 921 for use in connection with a removable memory card 923, etc. However, it is envisioned that other removable or non-removable, volatile or non-volatile computer storage media can be used in the exemplary computing system environment 900, including, but not limited to, magnetic tape cassettes, DVDs, digital video tape, solid state RAM, solid state ROM, etc. These various removable or non-removable, volatile or non-volatile magnetic media are in communication with the processing unit 904 and other components of the computer 900 via the system bus 906. The drives and their associated computer storage media discussed above and illustrated in FIG. 7 provide storage of operating systems, computer-readable instructions, application programs, data structures, program modules, program data and other instruction-based computer-readable code for the computer 900 (whether duplicative or not of this information and data in the system memory 908).

A user may enter commands, information, and data into the computer 900 through certain attachable or operable input devices, such as a keyboard 924, a mouse 926, etc., via a user input interface 928. Of course, a variety of such input devices may be utilized, e.g., a microphone, a trackball, a joystick, a touchpad, a touch-screen, a scanner, etc., including any arrangement that facilitates the input of data, and information to the computer 900 from an outside source. As discussed, these and other input devices are often connected to the processing unit 904 through the user input interface 928 coupled to the system bus 906, but may be connected by other interface and bus structures, such as a parallel port, game port, or a universal serial bus (USB). Still further, data and information can be presented or provided to a user in an intelligible form or format through certain output devices, such as a monitor 930 (to visually display this information and data in electronic form), a printer 932 (to physically display this information and data in print form), a speaker 934 (to audibly present this information and data in audible form), etc. All of these devices are in communication with the computer 900 through an output interface 936 coupled to the system bus 906. It is envisioned that any such peripheral output devices be used to provide information and data to the user.

The computer 900 may operate in a network environment 938 through the use of a communications device 940, which is integral to the computer or remote therefrom. This communications device 940 is operable by and in communication to the other components of the computer 900 through a communications interface 942. Using such an arrangement, the computer 900 may connect with or otherwise communicate with one or more remote computers, such as a remote computer 944, which may be a personal computer, a server, a router, a network personal computer, a peer device, or other common network nodes, and typically includes many or all of the components described above in connection with the computer 900. Using appropriate communication devices 940, e.g., a modem, a network interface or adapter, etc., the computer 900 may operate within and communicate through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 900, 944 may be used.

As used herein, the computer 900 includes or is operable to execute appropriate custom-designed or conventional software to perform and implement the processing steps of the method and system of the present invention, thereby forming a specialized and particular computing system. Accordingly, the presently-invented method and system may include one or more computers 900 or similar computing devices having a computer-readable storage medium capable of storing computer-readable program code or instructions that cause the processing unit 902 to execute, configure, or otherwise implement the methods, processes, and transformational data manipulations discussed hereinafter in connection with the present invention. Still further, the computer 900 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

Although the invention has been described in detail for the purpose of illustration based on what is currently considered to be the most practical and preferred embodiment or aspects, it is to be understood that such detail is solely for that purpose and that the invention is not limited to the disclosed embodiment or aspects, but, on the contrary, is intended to cover modifications and equivalent arrangements that are within the spirit and scope of the appended claims. For example, it is to be understood that the present invention contemplates that, to the extent possible, one or more features of any embodiment or aspect can be combined with one or more features of any other embodiment or aspect.

What is claimed is:

1. A computer-implemented method for an air brake system of a train comprising at least one locomotive and at least one railcar, the air brake system comprising: (a) at least one air brake arrangement associated with the at least one railcar and/or the at least one locomotive and configured to directly or indirectly urge at least one brake shoe towards and against at least one wheel of the at least one railcar and/or the at least one locomotive; and (b) at least one hand brake arrangement associated with the at least one railcar and/or the at least one locomotive and configured to directly or indirectly urge the at least one brake shoe towards or hold the at least one brake shoe against the at least one wheel of the at least one railcar and/or the at least one locomotive, the method comprising:
(i) determining consist data associated with the train;
(ii) determining track data comprising location data and grade data;
(iii) determining required train holding force based at least partially on the consist data and the track data; and
(iv) determining hand brake arrangement actuation data based at least partially on the required train holding force.

2. The computer-implemented method of claim 1, wherein the consist data comprises at least one of the following: a number of cars of the train, a length of the train, a weight of the train, or any combination thereof.

3. The computer-implemented method of claim 1, further comprising issuing a command to at least one user to set at least one specified hand brake arrangement.

4. The computer-implemented method of claim 1, wherein the hand brake arrangement actuation data comprises at least one of the following: a specified number of hand brake arrangements to be actuated, at least one specified hand brake arrangement to be actuated, or any combination thereof.

5. The computer-implemented method of claim 1, wherein the at least one hand brake arrangement is automated, the method further comprising transmitting a command directly or indirectly to the at least one hand brake arrangement to cause the hand brake arrangement to actuate.

6. The computer-implemented method of claim 5, wherein the command is transmitted over an existing trainline extending at least partially along the train.

7. The computer-implemented method of claim 5, wherein the at least one railcar comprises a local controller configured to control the air brake system of the at least one railcar, the command transmitted directly or indirectly to the local controller.

8. The computer-implemented method of claim 5, wherein the at least one hand brake arrangement comprises at least one motor configured to mechanically actuate the at least one hand brake and cause the at least one brake shoe to be urged towards or held against the at least one wheel of the at least one railcar and/or the at least one locomotive.

9. The computer-implemented method of claim 8, further comprising determining force data for a specified hand brake arrangement based at least partially on motor data.

10. The computer-implemented method of claim 9, wherein the motor data comprises at least one of the following: motor voltage data, motor current data, torque data, gear data, ratio data, or any combination thereof.

11. The computer-implemented method of claim 9, wherein the force data comprises holding force data associated with a specified railcar and/or locomotive.

12. The computer-implemented method of claim 8, wherein the hand brake arrangement further comprises at least one linkage directly or indirectly attached at one end to the at least one brake shoe and at the other end to an arrangement configured to move, urge, and/or actuate the at least one linkage, thereby urging the at least one brake shoe towards or holding the at least one brake shoe against the at least one wheel, or releasing the tension, such that the at least one brake shoe moves away or is capable of moving away from the at least one wheel.

13. The computer-implemented method of claim 12, further comprising:
causing the motor to take up any slack in the at least one linkage; and
causing the motor to apply a specified level of torque to the at least one linkage.

14. The computer-implemented method of claim 1, further comprising receiving feedback data representing at least one of the following: a specified number of hand brake arrangements have or have not been actuated, at least one specified hand brake arrangement has or has not been actuated, force data, incomplete operation data, issue data, alert data, or any combination thereof.

15. The computer-implemented method of claim 1, further comprising:
determining whether the at least one air brake arrangement associated with the at least one railcar and/or the at least one locomotive is activated; and
if the at least one air brake arrangement is activated, causing the at least one hand brake arrangement to be released.

16. The computer-implemented method of claim 15, wherein the determining step and the causing step are implemented through communication over a trainline extending at least partially along the train.

17. The computer-implemented method of claim 15, further comprising receiving confirmation data that the at least one hand brake arrangement has been released.

18. A system for an air brake system of a train comprising at least one locomotive and at least one railcar, the air brake system comprising: (a) at least one air brake arrangement associated with the at least one railcar and/or the at least one locomotive and configured to directly or indirectly urge at least one brake shoe towards and against at least one wheel of the at least one railcar and/or the at least one locomotive; and (b) at least one hand brake arrangement associated with the at least one railcar and/or the at least one locomotive and configured to directly or indirectly urge the at least one brake shoe towards or hold the at least one brake shoe against the at least one wheel of the at least one railcar and/or the at least one locomotive, the system comprising:
on at least one computer having a storage medium with program instructions stored thereon, which, when executed by at least one processor of the at least one computer, causes the processor to:
(i) determine consist data associated with the train;
(ii) determine track data comprising location data and grade data;
(iii) determine required train holding force based at least partially on the consist data and the track data; and
(iv) determine hand brake arrangement actuation data based at least partially on the required train holding force.

19. A hand brake arrangement for an air brake system of a train comprising at least one locomotive and at least one railcar, the air brake system comprising at least one air brake arrangement associated with the at least one railcar and/or the at least one locomotive and configured to directly or indirectly urge at least one brake shoe towards or hold the at least one brake shoe against at least one wheel of the at least one railcar and/or the at least one locomotive, the hand brake arrangement comprising:
at least one linkage directly or indirectly attached at one end to the at least one brake shoe and at the other end to an arrangement configured to move, urge, and/or actuate the at least one linkage, thereby directly or indirectly urging the at least one brake shoe towards or holding the at least one brake shoe against the at least one wheel, or releasing the tension, such that the at least one brake shoe moves away or is capable of moving away from the at least one wheel;
a hand wheel in operational engagement with at least one component of the arrangement and configured to move the at least one component upon manual rotation of the hand wheel;
at least one motor in operational engagement with the at least one component of the arrangement and configured to automatically move the at least one component upon operation of the at least one motor; and
at least one hand brake battery configured to at least partially power the at least one motor.

20. The hand brake arrangement of claim 19, wherein the at least one hand brake battery comprises at least one rechargeable battery.

21. The hand brake arrangement of claim 20, wherein the at least one rechargeable battery is charged through at least one of the following: an electrical connection with a trainline extending at least partially along the train, an electrical connection with at least one solar power arrangement, an electrical connection with at least one axle power generator arrangement, an electrical connection with a local controller, or any combination thereof.

22. The hand brake arrangement of claim 19, wherein the at least one hand brake battery is positioned near or mounted on at least one component of the hand brake arrangement.

23. The hand brake arrangement of claim 19, wherein the at least one motor is configured to be disengaged from or disabled with respect to at least one component of the hand brake arrangement when in an unpowered state.

24. The hand brake arrangement of claim 19, wherein the at least one motor is configured to be selectively disengaged from or disabled with respect to at least one component of the hand brake arrangement.

25. The hand brake arrangement of claim 19, wherein the at least one motor is automatically actuated based at least in part upon the sensing or determination of an emergency brake application.

26. The hand brake arrangement of claim 19, wherein, after actuation, the hand brake arrangement is released based upon at least one of the following: a push-button arrangement, a data signal, a data radio signal, or any combination thereof.

27. The hand brake arrangement of claim 26, wherein the actuation or release of the hand brake arrangement is directly or indirectly communicated to an on-board controller of the train.

28. The hand brake arrangement of claim 27, wherein the communication is effected over a trainline extending at least partially along the train.

29. A computer-implemented method for an air brake system of a train comprising at least one locomotive and at least one railcar, the air brake system comprising: (a) at least one air brake arrangement associated with the at least one railcar and/or the at least one locomotive and configured to directly or indirectly urge at least one brake shoe towards and against at least one wheel of the at least one railcar and/or the at least one locomotive; and (b) at least one hand brake arrangement associated with the at least one railcar and/or the at least one locomotive and configured to directly or indirectly urge the at least one brake shoe towards or hold the at least one brake shoe against the at least one wheel of the at least one railcar and/or the at least one locomotive, the method comprising:
(i) determining consist data associated with the train;
(ii) determining track data comprising location data and grade data;
(iii) determining required train holding force based at least partially on the consist data and the track data; and
(iv) determining hand brake arrangement actuation data based at least partially on the required train holding force.

30. The computer-implemented method of claim 29, wherein the consist data comprises at least one of the following: a number of cars of the train, a length of the train, a weight of the train, or any combination thereof.

31. The computer-implemented method of claim 29 or 30, further comprising issuing a command to at least one user to set at least one specified hand brake arrangement.

32. The computer-implemented method of any of claims 29-31, wherein the hand brake arrangement actuation data comprises at least one of the following: a specified number of hand brake arrangements to be actuated, at least one specified hand brake arrangement to be actuated, or any combination thereof.

33. The computer-implemented method of any of claims 29-32, wherein the at least one hand brake arrangement is automated, the method further comprising transmitting a command directly or indirectly to the at least one hand brake arrangement to cause the hand brake arrangement to actuate.

34. The computer-implemented method of claim 33, wherein the command is transmitted over an existing trainline extending at least partially along the train.

35. The computer-implemented method of claim 33 or 34, wherein the at least one railcar comprises a local controller configured to control the air brake system of the at least one railcar, the command transmitted directly or indirectly to the local controller.

36. The computer-implemented method of any of claims 33-35, wherein the at least one hand brake arrangement comprises at least one motor configured to mechanically actuate the at least one hand brake and cause the at least one brake shoe to be urged towards or held against the at least one wheel of the at least one railcar and/or the at least one locomotive.

37. The computer-implemented method of claim 36, further comprising determining force data for a specified hand brake arrangement based at least partially on motor data.

38. The computer-implemented method of claim 36 or 37, wherein the motor data comprises at least one of the following: motor voltage data, motor current data, torque data, gear data, ratio data, or any combination thereof.

39. The computer-implemented method of any of claims 36-38, wherein the force data comprises holding force data associated with a specified railcar and/or locomotive.

40. The computer-implemented method of any of claims 36-39, wherein the hand brake arrangement further comprises at least one linkage directly or indirectly attached at one end to the at least one brake shoe and at the other end to an arrangement configured to move, urge, and/or actuate the at least one linkage, thereby urging the at least one brake shoe towards or holding the at least one brake shoe against the at least one wheel, or releasing the tension, such that the at least one brake shoe moves away or is capable of moving away from the at least one wheel.

41. The computer-implemented method of claim 40, further comprising:
causing the motor to take up any slack in the at least one linkage; and
causing the motor to apply a specified level of torque to the at least one linkage.

42. The computer-implemented method of any of claims 29-41, further comprising receiving feedback data representing at least one of the following: a specified number of hand brake arrangements have or have not been actuated, at least one specified hand brake arrangement has or has not been actuated, force data, incomplete operation data, issue data, alert data, or any combination thereof.

43. The computer-implemented method of any of claims 29-42, further comprising:
determining whether the at least one air brake arrangement associated with the at least one railcar and/or the at least one locomotive is activated; and
if the at least one air brake arrangement is activated, causing the at least one hand brake arrangement to be released.

44. The computer-implemented method of claim 43, wherein the determining step and the causing step are implemented through communication over a trainline extending at least partially along the train.

45. The computer-implemented method of claim 44, further comprising receiving confirmation data that the at least one hand brake arrangement has been released.

46. A system for an air brake system of a train comprising at least one locomotive and at least one railcar, the air brake system comprising: (a) at least one air brake arrangement associated with the at least one railcar and/or the at least one locomotive and configured to directly or indirectly urge at least one brake shoe towards and against at least one wheel of the at least one railcar and/or the at least one locomotive; and (b) at least one hand brake arrangement associated with the at least one railcar and/or the at least one locomotive and configured to directly or indirectly urge the at least one brake shoe towards or hold the at least one brake shoe against the at least one wheel of the at least one railcar and/or the at least one locomotive, the system comprising:
on at least one computer having a storage medium with program instructions stored thereon, which, when executed by at least one processor of the at least one computer, causes the processor to:
(i) determine consist data associated with the train;
(ii) determine track data comprising location data and grade data;
(iii) determine required train holding force based at least partially on the consist data and the track data; and
(iv) determine hand brake arrangement actuation data based at least partially on the required train holding force.

47. A hand brake arrangement for an air brake system of a train comprising at least one locomotive and at least one railcar, the air brake system comprising at least one air brake arrangement associated with the at least one railcar and/or the at least one locomotive and configured to directly or indirectly urge at least one brake shoe towards or hold the at least one brake shoe against at least one wheel of the at least one railcar and/or the at least one locomotive, the hand brake arrangement comprising:
at least one linkage directly or indirectly attached at one end to the at least one brake shoe and at the other end to an arrangement configured to move, urge, and/or actuate the at least one linkage, thereby directly or indirectly urging the at least one brake shoe towards or holding the at least one brake shoe against the at least one wheel, or releasing the tension, such that the at least one brake shoe moves away or is capable of moving away from the at least one wheel;
a hand wheel in operational engagement with at least one component of the arrangement and configured to move the at least one component upon manual rotation of the hand wheel;
at least one motor in operational engagement with the at least one component of the arrangement and configured to automatically move the at least one component upon operation of the at least one motor; and
at least one hand brake battery configured to at least partially power the at least one motor.

48. The hand brake arrangement of claim 47, wherein the at least one hand brake battery comprises at least one rechargeable battery.

49. The hand brake arrangement of claim 48, wherein the at least one rechargeable battery is charged through at least one of the following: an electrical connection with a trainline extending at least partially along the train, an electrical connection with at least one solar power arrangement, an electrical connection with at least one axle power generator arrangement, an electrical connection with a local controller, or any combination thereof.

50. The hand brake arrangement of any of claims 47-49, wherein the at least one hand brake battery is positioned near or mounted on at least one component of the hand brake arrangement.

51. The hand brake arrangement of any of claims 47-50, wherein the at least one motor is configured to be disengaged from or disabled with respect to at least one component of the hand brake arrangement when in an unpowered state.

52. The hand brake arrangement of any of claims 47-51, wherein the at least one motor is configured to be selectively disengaged from or disabled with respect to at least one component of the hand brake arrangement.

53. The hand brake arrangement of any of claims 47-52, wherein the at least one motor is automatically actuated based at least in part upon the sensing or determination of an emergency brake application.

54. The hand brake arrangement of any of claims 47-53, wherein, after actuation, the hand brake arrangement is released based upon at least one of the following: a push-button arrangement, a data signal, a data radio signal, or any combination thereof.

55. The hand brake arrangement of claim 54, wherein the actuation or release of the hand brake arrangement is directly or indirectly communicated to an on-board controller of the train.

56. The hand brake arrangement of claim 55, wherein the communication is effected over a trainline extending at least partially along the train.
